(19) United States
(12) Patent Application Publication
(10) Pub. No.: US 2014/0345058 A1
(43) Pub. Date: Nov. 27, 2014

(54) Pressure Monitoring and Management Cushion System And Method Of Use

(71) Applicant: SEC Medical Development, Inc., San Antonio, TX (US)

(72) Inventors: Abram Escobedo, San Antonio, TX (US); Oscar Cantu, San Antonio, TX (US); Aaron Dean Saul, JR., Harper, TX (US)

(21) Appl. No.: 14/283,810

(22) Filed: May 21, 2014

Related U.S. Application Data
(60) Provisional application No. 61/825,990, filed on May 21, 2013.

(51) Int. Cl. A61G 7/057; A61G 5/10; A47C 27/08

(52) U.S. Cl. CPC A61G 7/05769; A47C 27/083; A47C 27/084; A61G 5/1043; A61G 2005/1045; A61G 2005/1091
USPC 5/655.3

(57) ABSTRACT

A system and method of use directed to a pressure monitoring and management system for a subject in the seated or laying position is disclosed herein. More specifically, the present invention relates to a system and method of use for monitoring and managing the pressure distribution and alleviation of pressure of a subject in the seated or laying position for the avoidance of skin and tissue breakdown also known as decubitus ulcers or pressure sores. In one embodiment, the system is comprised of a control member, an air supply member, and bladder members. In another embodiment, the system is also comprised of a user interface member and pressure sensor members. In yet another embodiment, the system is also comprised of moisture sensor members.

### CROSS-REFERENCE TO RELATED APPLICATIONS

This application claims the benefit under Title 35 United States Code §119(e) of U.S. Provisional Patent Application Ser. No.: 61/825,990; Filed: May 21, 2013, the full disclosure of which is incorporated herein by reference.

### STATEMENT REGARDING FEDERALLY SPONSORED

RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to a pressure monitoring and management system for a subject in the seated or laying position. More specifically, the present invention relates to a system and method of use for monitoring and managing the pressure distribution and alleviation of pressure of a subject in the seated or laying position for the avoidance of skin and tissue breakdown also known as decubitus ulcers or pressure sores.

### BACKGROUND OF THE INVENTION

Without limiting the scope of the disclosed system and method, the background is described in connection with a novel system and approach directed to a pressure monitoring and management system for a subject in the seated or laying position.

Pressure ulcers, also known as decubitus ulcers are injuries to the skin and/or underlying tissue as a result of pressure. These ulcers develop due to pressure being applied to soft tissue resulting in completely or partially obstructed blood flow to the soft tissue. Pressure ulcers most commonly develop in subjects who are immobile or are confined to wheelchairs. Individuals who are critically ill or injured are very susceptible to pressure sores as they are very difficult to move. In addition, moisture is a contributing factor as well for the development of pressure ulcers. Moisture on the skin causes the skin to lose the dry outer layer and reduces the tolerance of the skin for pressure and shear. This situation may be aggravated by other conditions such as excess moisture from incontinence, perspiration, or exudate. Over time, this excess moisture may cause the bonds between epithelial cells to weaken, thus resulting in the maceration of the epidermis. Because of these factors, hospital settings see a high rate of pressure sores in patients.

Primary prevention of pressure ulcers is to redistribute the pressure of the subject by repositioning them periodically so as to alleviate the pressure from where it was historically allocated. This approach has been well documented since the 19^{th} century. Current methods employed involve physically repositioning the patient by a healthcare professional or caretaker. This involves keeping track of repositioning time intervals and estimating or guessing where the pressure allocation of the subject's weight was currently distributed over the bed or wheelchair. An additional preventive measure is to keep the subject's skin free from exposure to moisture such as urine. Current methods employed involve a healthcare professional or caretaker visually inspecting the subject.

While all of the aforementioned approaches may fulfill their unique purposes, none of them fulfill the need for a practical and effective means for providing a pressure monitoring and management system for a subject in the seated or laying position.

The present invention therefore proposes a novel system and method of use for monitoring and managing the pressure distribution and alleviation of pressure of a subject in the seated or laying position for the avoidance of skin and tissue breakdown also known as decubitus ulcers or pressure sores.

### BRIEF SUMMARY OF THE INVENTION

The present invention, therefore, provides a system and method of use for monitoring and managing the pressure distribution and alleviation of pressure of a subject in the seated or laying position for the avoidance of skin and tissue breakdown also known as decubitus ulcers or pressure sores.

In one embodiment, the system is comprised of a control member, an air supply member, and bladder members. The bladder members are utilized to redistribute the weight allocation of the subject by controlling the inflation pressure of the bladder members by the air supply member. The control member is comprised of the means to select particular bladder members and inflate or deflate as needed the chosen bladder member. In another embodiment, the system is also comprised of a user interface member and pressure sensor members. The interface member may be integrated into the control member. The interface member is comprised of the means to provide displays and controls to the subject or an individual monitoring the subject. The interface member is communicatively coupled to the control member either through a physical wired connection or a wireless connection. The interface member allows an individual to receive weight distributions of the bladder members, controls to manage the weight distributions on the bladder members, and alerts for timed intervals or weight distribution anomalies. In yet another embodiment, the system is also comprised of moisture sensor members. The moisture sensor member allows the detection of moisture on the bladder members.

In summary, the present invention generally relates to a system and method of use directed to a pressure monitoring and management system for a subject in the seated or laying position. More specifically, the present invention relates to a system and method of use for monitoring and managing the pressure distribution and alleviation of pressure of a subject in the seated or laying position for the avoidance of skin and tissue breakdown also known as decubitus ulcers or pressure sores.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a top view system architecture diagram of the pressure monitoring and management cushion system in accordance with embodiments of the disclosure;

FIG. 2 is a front perspective view of the pressure monitoring and management cushion system in accordance with embodiments of the disclosure;

FIG. 3 is a front perspective view of the pressure monitoring and management cushion system being utilized with a wheel chair in accordance with embodiments of the disclosure;

FIG. 4A is a right side cross-sectional view of the bladder members with both bladder members being inflated in accordance with embodiments of the disclosure;

FIG. 4B is a right side cross-sectional view of the bladder members with both bladder members being deflated in accordance with embodiments of the disclosure;

FIG. 4C is a right side cross-sectional view of the bladder members with the top bladder member being inflated in accordance with embodiments of the disclosure;

FIG. 4D is a right side cross-sectional view of the bladder members with the bottom bladder member being inflated in accordance with embodiments of the disclosure;

FIG. 5A is a top side cross-sectional view of the bladder members with the bladder members being inflated in accordance with embodiments of the disclosure;

FIG. 5B is a top side cross-sectional view of the bladder members with the bladder members being deflated in accordance with embodiments of the disclosure;

FIG. 5C is a top side cross-sectional view of the bladder members with the middle and right side bladder members being inflated in accordance with embodiments of the disclosure;

FIG. 5D is a top side cross-sectional view of the bladder members with the left and right side bladder members being inflated in accordance with embodiments of the disclosure;

FIG. 5E is a top side cross-sectional view of the bladder members with the left and middle side bladder members being inflated in accordance with embodiments of the disclosure;

FIG. 5F is a top side cross-sectional view of the bladder members with only the left side bladder member being inflated in accordance with embodiments of the disclosure;

FIG. 6A is a right side view of the pressure monitoring and management cushion system being utilized with a wheel chair and further illustrating a patient siting on top of the bladder members with both bladder members being inflated in accordance with embodiments of the disclosure;

FIG. 6B is a right side view of the pressure monitoring and management cushion system being utilized with a wheel chair and further illustrating a patient siting on top of the bladder members with the rear bladder member being inflated in accordance with embodiments of the disclosure;

FIG. 6C is a right side view of the pressure monitoring and management cushion system being utilized with a wheel chair and further illustrating a patient siting on top of the bladder members with the front bladder member being inflated in accordance with embodiments of the disclosure;

FIG. 7A is a front view of the pressure monitoring and management cushion system being utilized with a wheel chair and further illustrating a patient siting on top of the bladder members with all bladder members being inflated in accordance with embodiments of the disclosure;

FIG. 7B is a front view of the pressure monitoring and management cushion system being utilized with a wheel chair and further illustrating a patient siting on top of the bladder members with the middle and right side bladder members being inflated in accordance with embodiments of the disclosure;

FIG. 7C is a front view of the pressure monitoring and management cushion system being utilized with a wheel chair and further illustrating a patient siting on top of the bladder members with only the left side bladder member being inflated in accordance with embodiments of the disclosure;

FIG. 7D is a front view of the pressure monitoring and management cushion system being utilized with a wheel chair and further illustrating a patient siting on top of the bladder members with the left and right side bladder members being inflated in accordance with embodiments of the disclosure.

### DETAILED DESCRIPTION OF THE INVENTION

Disclosed herein is an improved system and method of use for monitoring and managing the pressure distribution and alleviation of pressure of a subject in the seated or laying position for the avoidance of skin and tissue breakdown also known as decubitus ulcers or pressure sores. The numerous innovative teachings of the present invention will be described with particular reference to several embodiments (by way of example, and not of limitation).

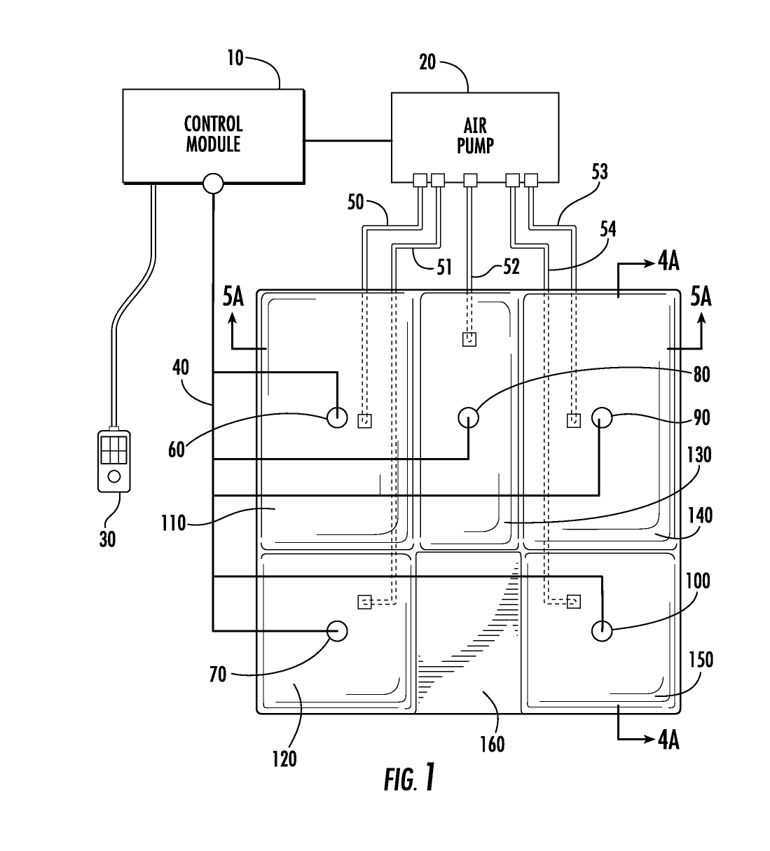

Reference is first made to FIG. 1, a top view system architecture diagram of the pressure monitoring and management cushion system in accordance with embodiments of the disclosure. In one embodiment, the system is comprised of a control member 10, an air supply member 20, and bladder members 110, 120, 130, 140, 150. The bladder members 110, 120, 130, 140, 150 are inflatable structures or components which hold air or other various gases and in one embodiment is made of a polymer or rubber. The bladder members 110, 120, 130, 140, 150 may take on various numbers (Six as illustrated in this embodiment), shapes and sizes depending on the area to be covered for the patient or subject to sit or lay on. In addition the bladder member may be attached to each other to form a bladder member surface as illustrated or may not be attached to each other. In other embodiments, the bladder members are attached to or embedded in the surface to be utilized. For example, the bladder member(s) may be attached to the bed's surface or embedded just underneath the surface of the bed housed internally within the bed. In this illustration, the patient or subject would sit on the bladder members 110, 120, 130, 140, 150 having their rear on bladder members 110, 130, and 140 with their legs extending on the perimeter outward on bladder members 120 and 150. The bladder members 110, 120, 130, 140, 150 are utilized to redistribute the weight allocation of the subject by controlling the inflation pressure of the bladder members 110, 120, 130, 140, 150 by the air supply member 20. The air supply member 20 is a component that is able to supply air to and/or remove air from the bladder members 110, 120, 130, 140, 150. 110. In this illustration, the air supply member 20 is characterized by an air pump and is connected to the bladder members 110, 120, 130, 140, 150 by connection members 50, 51, 52, 53, 54. In another embodiment, the system also is comprised of a control member 10. The control member 10 is comprised of the means to select particular bladder members 110, 120, 130, 140, 150 and inflate or deflate as needed the chosen bladder member. In another embodiment, the control member 10 is also comprised of the means to receive, store, process, and calculate data elements such as but not limited to pressure, time, and moisture data. In yet another embodiment, the system is also comprised of pressure sensors 60, 70, 80, 90, 100 such as pressure transducers or piezoelectric transducers. These pressure sensors 60, 70, 80, 90, 100 are attached to the bladder members 110, 120, 130, 140, 150 to provide the system with pressure information at the bladder member 110, 120, 130, 140, 150 locations. The pressure sensors 60, 70, 80, 90, 100 provide the system with a pressure distribution for the bladder members 110, 120, 130, 140, 150. The pressure sensor members 60, 70, 80, 90, 100 are communicatively connected such as electrically 40 to the control member 10. The control member 10 is also communicatively coupled with the air supply member 20. In another embodiment, the control member 10 and the air supply member 20 are one integrated member and are not separate components. In yet another embodiment, the system is also comprised of moisture sensors 60, 70, 80, 90, 100 integrated with the pressure sensors 60, 70, 80, 90, 100. These moisture sensors 60, 70, 80, 90, 100 are attached to the bladder members 110, 120, 130, 140, 150 to provide the system with moisture information at the bladder member 110, 120, 130, 140, 150 locations. The moisture sensor members 60, 70, 80, 90, 100 are communicatively connected such as electrically 40 to the control member 10. If moisture is detected, the system can alert to the condition so that the patient can be attended to. In yet another embodiment, the system is also comprised of a user interface member 30. The user interface member 30 is a component that allows the control and display of information from the system such as but limited to pressure information, moisture information, and time information. The user interface member 10 for example may be a workstation, laptop, display screen, and/or mobile device such as a phone. The user interface may be communicatively coupled to the control module 10 by being physically hard wired or wirelessly. The user interface 10 allows an individual to control threshold settings for alerts such as when moisture is detected, pressure readings are reached, or duration of a pressure distribution on the bladder members. In addition, an individual can utilize the user interface 10 to monitor the bladder members 110, 120, 130, 140, 150 and control the inflation or deflation of bladder members 110, 120, 130, 140, 150. For specificity, the bladder member does not need to be fully inflated or deflated and the controls may be set based on pressures within the bladder members 110, 120, 130, 140, 150. In another embodiment, the user interface member 30 and the control module 10 are one component.

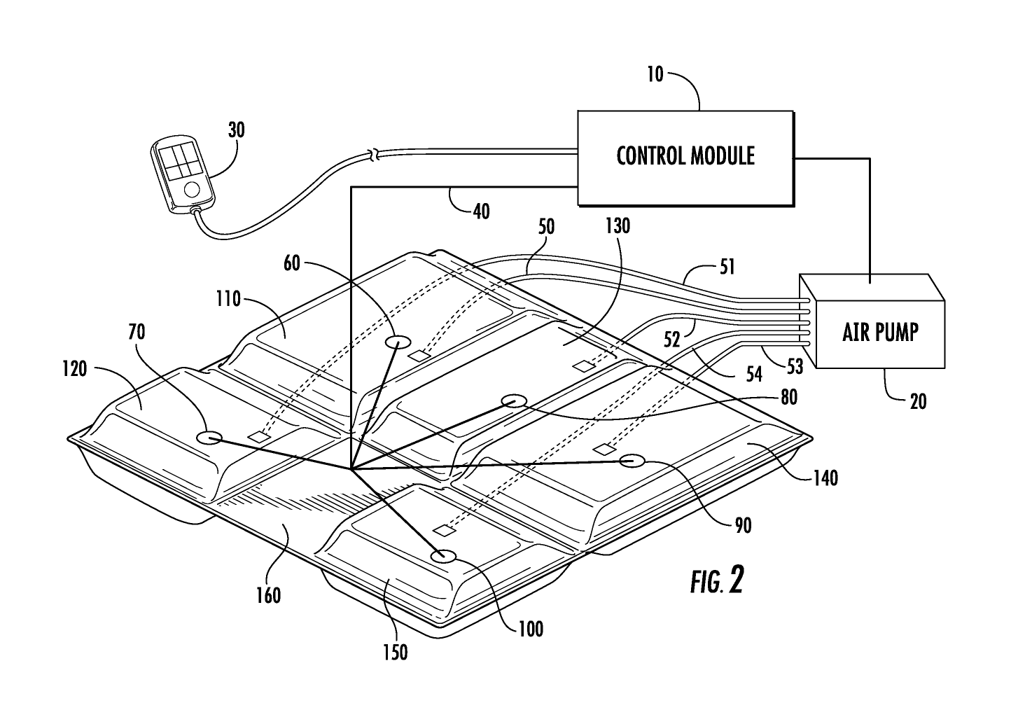

Reference is next made to FIG. 2, a front perspective view of the pressure monitoring and management cushion system in accordance with embodiments of the disclosure. In this illustration the bladder members 110, 120, 130, 140, 150 are better seen. In one embodiment, region 160 is not a bladder member 110, 120, 130, 140, 150 as this area would be positioned between the patient's legs. In another embodiment, 160 is a bladder member.

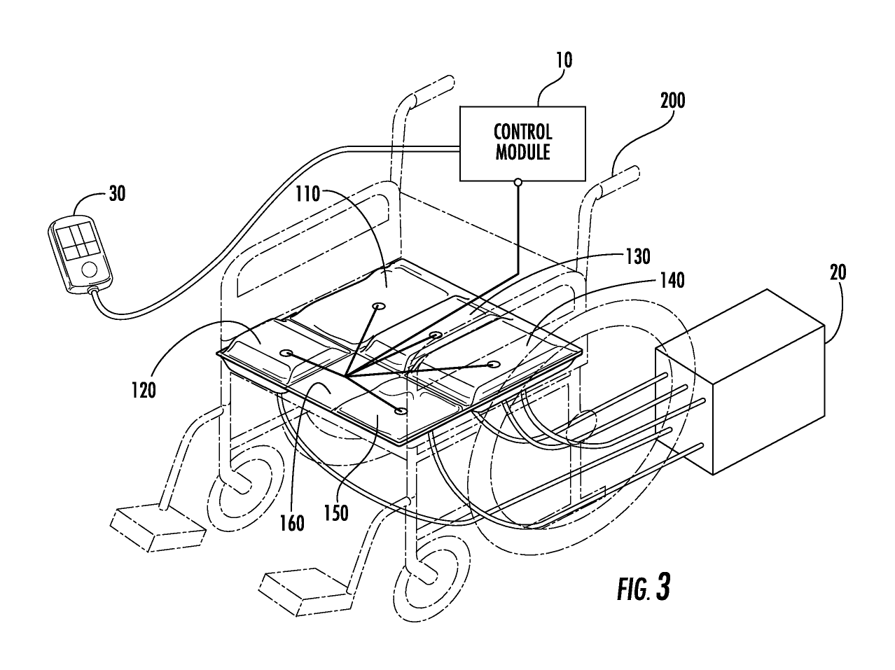

Reference is now made to FIG. 3, a front perspective view of the pressure monitoring and management cushion system being utilized with a wheel chair 200 in accordance with embodiments of the disclosure. In this illustration, the system layout with the wheel chair can be seen.

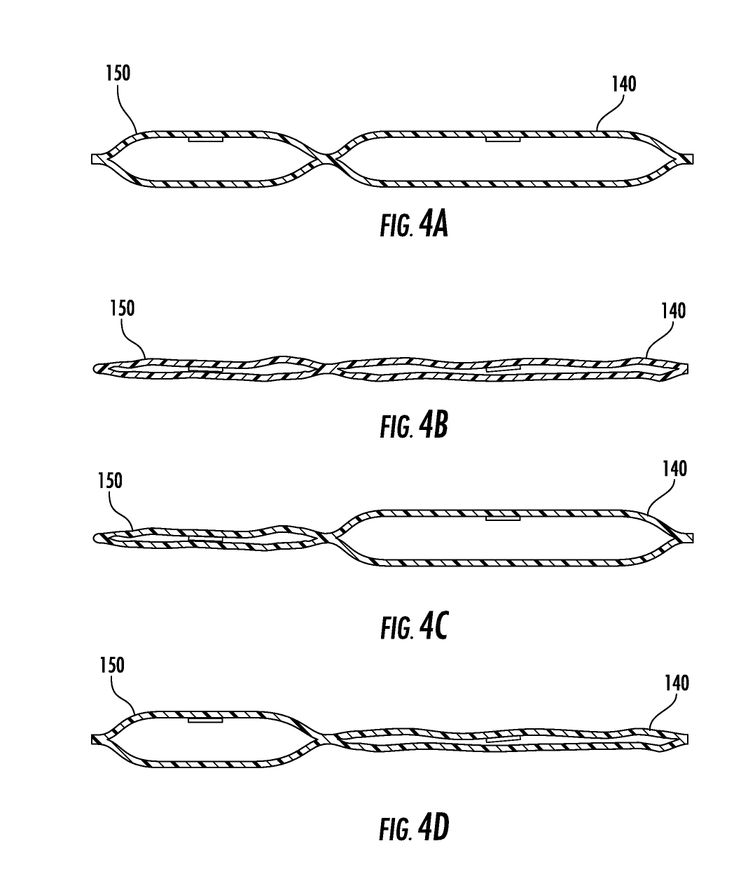

Reference is next made to FIGS. 4A-4D, right side cross-sectional views of the bladder members 140, 150 with various bladder members being inflated in accordance with embodiments of the disclosure. In FIG. 4A both bladder members 150 and 140 are inflated, positioning the patient evenly along this viewed plane. In FIG. 4B both bladder members 150 and 140 are deflated, positioning the patient evenly along this viewed plane. In FIG. 4C bladder member 150 is deflated and bladder member 140 is inflated, positioning the patient leaning forward along this viewed plane. That is, amongst these two bladder members, the patient's weight is shifted to the forward bladder member 150. In FIG. 4D bladder member 150 is inflated and bladder member 140 is deflated, positioning the patient leaning backward along this viewed plane. That is, amongst these two bladder members, the patient's weight is shifted to the rear bladder member 140. As can be seen from these illustrations, different combinations and variations in pressure could be achieved among the various bladder members 110, 120, 130, 140, 150 to achieve a desired pressure variation on the patient.

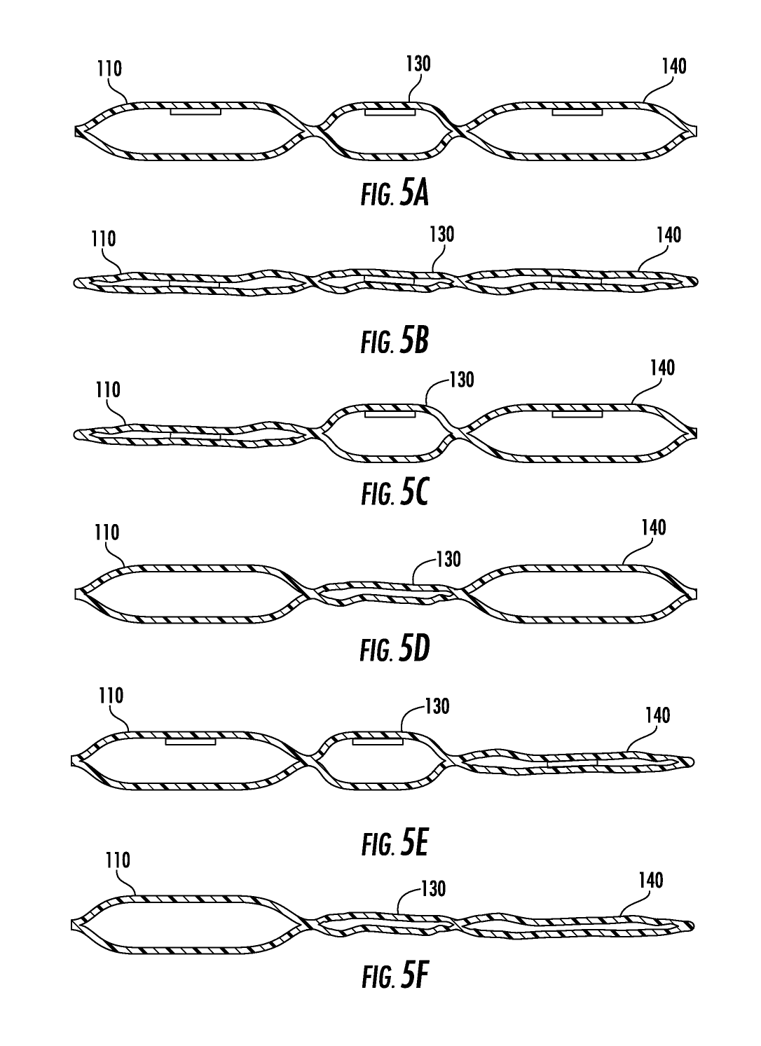

Reference is next made to FIGS. 5A-5F, top side cross-sectional views of the bladder members 110, 130, 140 with various bladder members being inflated in accordance with embodiments of the disclosure. In FIG. 5A bladder member 110 is inflated, bladder member 130 is inflated, and bladder member 140 is inflated positioning the patient evenly along the viewed plane. In FIG. 5B bladder member 110 is deflated, bladder member 130 is deflated, and bladder member 140 is deflated also positioning the patient evenly along the viewed plane. In FIG. 5C bladder member 110 is deflated, bladder member 130 is inflated, and bladder member 140 is inflated positioning the patient leaning to their right along the viewed plane. That is, amongst these three bladder members, the patient's weight is shifted to the right bladder member 110. In FIG. 5D bladder member 110 is inflated, bladder member 130 is deflated, and bladder member 140 is inflated relieving any pressure along the center of their rear. In FIG. 5E bladder member 110 is inflated, bladder member 130 is inflated, and bladder member 140 is deflated positioning the patient leaning to their left along the viewed plane. That is, amongst these three bladder members, the patient's weight is shifted to the left bladder member 140. In FIG. 5F bladder member 110 is inflated, bladder member 130 is deflated, and bladder member 140 is deflated positioning the patient leaning even more so to their left along the viewed plane. That is, amongst these three bladder members, the patient's weight is shifted to the left bladder member 140 even more pronounced than FIG. 5E. As can be further seen from these illustrations, different combinations and variations in pressure could be achieved among the various bladder members 110, 120, 130, 140, 150 to achieve a desired pressure variation for the patient.

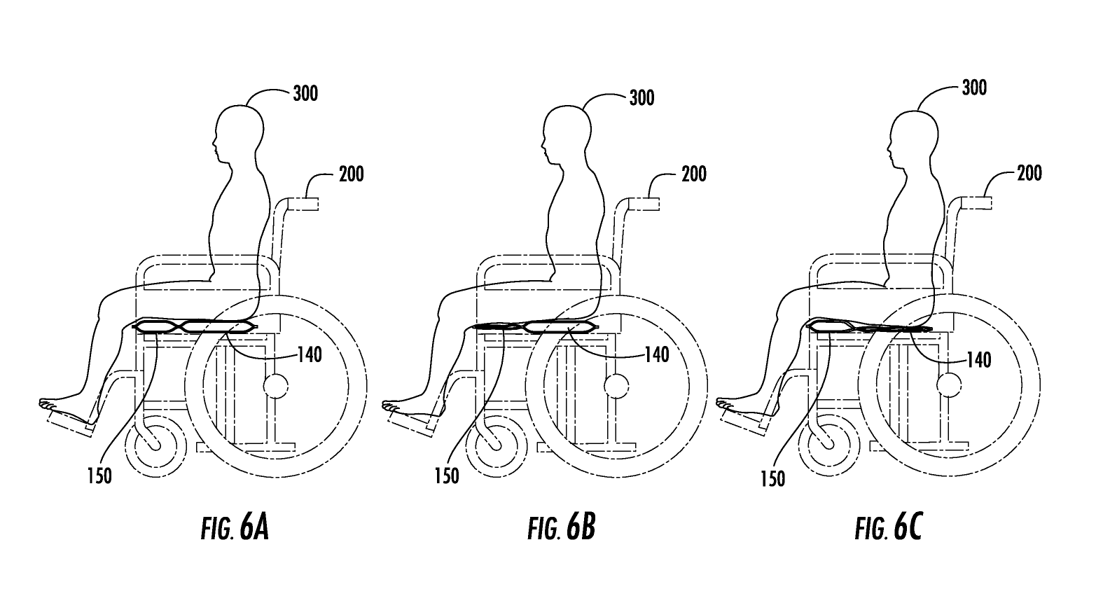

Reference is next made to FIGS. 6A-6C, right side views of the pressure monitoring and management cushion system being utilized with a wheel chair 200 and further illustrating a patient 300 siting on top of the bladder members 140, 150 with various bladder members being inflated in accordance with embodiments of the disclosure. In FIG. 6A both bladder members 150 and 140 are inflated, positioning the patient evenly along this viewed plane. In FIG. 6B bladder member 150 is deflated and bladder member 140 is inflated, positioning the patient leaning forward along this viewed plane. That is, amongst these two bladder members, the patient's weight is shifted to the forward bladder member 150. In FIG. 6C bladder member 150 is inflated and bladder member 140 is deflated, positioning the patient leaning backward along this viewed plane. That is, amongst these two bladder members, the patient's weight is shifted to the rear bladder member 140.

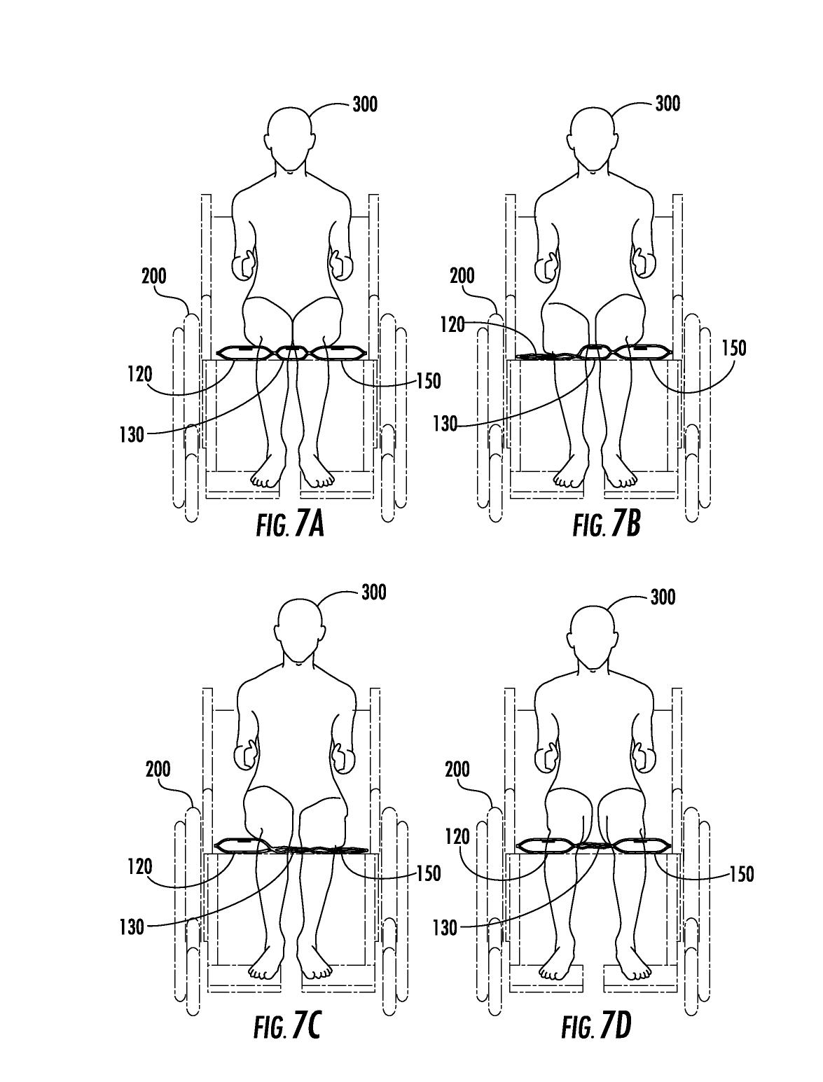

Reference is lastly made to FIGS. 7A-7D, front views of the pressure monitoring and management cushion system being utilized with a wheel chair 200 and further illustrating a patient 300 siting on top of the bladder members 120, 130, 150 with various bladder members being inflated in accordance with embodiments of the disclosure. In FIG. 7A bladder member 120 is inflated, bladder member 130 is inflated, and bladder member 150 is inflated positioning the patient evenly along the viewed plane. In FIG. 7B bladder member 120 is deflated, bladder member 130 is inflated, and bladder member 150 is inflated positioning the patient leaning to their right along the viewed plane. That is, amongst these three bladder members, the patient's weight is shifted to the right bladder member 120. In FIG. 7C bladder member 120 is inflated, bladder member 130 is deflated, and bladder member 150 is deflated positioning the patient leaning more pronounced to their left along the viewed plane. That is, amongst these three bladder members, the patient's weight is shifted to the left bladder member 150 even more pronounced than if bladder member 130 was not deflated. In FIG. 7D bladder member 120 is inflated, bladder member 130 is deflated, and bladder member 150 is inflated relieving any pressure along the center for these three bladder members.

As can be seen from these illustrations, different combinations and variations in pressure could be achieved among the various bladder members 110, 120, 130, 140, 150 to achieve a desired pressure variation on the patient. For example, bladder members 110, 120, 140, and 150 could be inflated with bladder member 130 deflated positioning the patient so that no weight or pressure is placed on the middle of the rear of the patient's sitting footprint on the bladder members. That is bladder members 110, 120, 140, and 150 would support the weight of the patient.

In brief, as described herein provides for an effective and efficient system and method of use for monitoring and managing the pressure distribution and alleviation of pressure of a subject in the seated or laying position for the avoidance of skin and tissue breakdown also known as decubitus ulcers or pressure sores.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the system and method of use for monitoring and managing pressure distribution and alleviation of pressure in various environments and conditions besides healthcare beds and wheel chairs. For example, the system may be employed in home health beds or residential beds, sofas, and chairs. In addition, the system may be employed in any environment where the monitoring and management of the pressure distribution and alleviation of pressure is needed for a subject. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A pressure monitoring and management cushion system comprising:
a bladder member configured to inflate and deflate, said bladder member disposed on a surface for a subject to sit or lay on.

2. The system of claim 1 further comprising two or more bladder members.

3. The system of claim 1 further comprising two or more bladder members having at least two said bladder members attached to each other to form a bladder member surface.

4. A pressure monitoring and management cushion system comprising:
a bladder member configured to inflate and deflate, said bladder member disposed on a surface for a subject to sit or lay on;
an air supply member connected to said bladder members and configured to inflate and deflate said bladder members.

5. The system of claim 4 further comprising two or more bladder members.

6. The system of claim 4 further comprising two or more bladder members having at least two said bladder members attached to each other to form a bladder member surface.

7. The system of claim 4 wherein said bladder members have a square geometric shape and said bladder member surface forms a square geometric shape.

8. A pressure monitoring and management cushion system comprising:
a bladder member configured to inflate and deflate, said bladder member disposed on a surface for a subject to sit or lay on;
an air supply member connected to said bladder members and configured to inflate and deflate said bladder members;
a control member connected to said air supply member and configured to allow the selection of individual bladder members for inflation and deflation.

9. The system of claim 8 further comprising two or more bladder members.

10. The system of claim 8 further comprising two or more bladder members having at least two said bladder members attached to each other to form a bladder member surface.

11. The system of claim 8 wherein said bladder members have a square geometric shape and said bladder member surface forms a square geometric shape.

12. The system of claim 8 wherein said control member is further configured to receive, store, calculate, and process time, pressure, and moisture data elements as well as monitor said bladder members.

13. The system of claim 8 further comprising at least one pressure sensor member coupled to at least one said bladder member and communicatively coupled to said control member.

14. The system of claim 12 wherein said pressure sensor member is a pressure transducer.

15. The system of claim 13 wherein said pressure transducer is a piezoelectric sensor.

16. The system of claim 8 further comprising at least one moisture sensor member coupled to at least one said bladder member and communicatively coupled to said control member.

17. The system of claim 8 wherein said control member further comprises a user interface member.

18. The system of claim 17 wherein said user interface is workstation, laptop, display screen, or mobile device.

19. The system of claim 8 wherein said control member is configured to alert on system conditions such as time, moisture, and pressure.

20. The system of claim 8 further comprising two or more bladder members having at least two said bladder members attached to each other to form a bladder member surface;
said control member is further configured to receive, store, calculate, and process time, pressure, and moisture data elements as well as monitor said bladder members;
at least one pressure sensor member coupled to at least one said bladder member and communicatively coupled to said control member;
at least one moisture sensor member coupled to at least one said bladder member and communicatively coupled to said control member;
said control member further comprises a user interface member;
and said control member is configured to alert on system conditions such as time, moisture, and pressure.
